(19) United States
(12) Patent Application Publication
(10) Pub. No.: US 2026/0038019 A1
(43) Pub. Date: Feb. 5, 2026

(54) PRODUCT INFORMATION PROCESSING METHOD AND ELECTRONIC DEVICE

(71) Applicant: Hangzhou Alibaba International Internet Industry Co., Ltd., Hangzhou (CN)

(72) Inventors: Renhao ZHOU, Hangzhou (CN); Feifei WU, Hangzhou (CN)

(21) Appl. No.: 19/356,322

(22) Filed: Oct. 13, 2025

Related U.S. Application Data
(63) Continuation of application No. PCT/CN2024/088089, filed on Apr. 16, 2024.

(30) Foreign Application Priority Data
Apr. 24, 2023 (CN) 202310459734.5

(51) Int. Cl. G06Q 30/0601; G06Q 30/0283

(52) U.S. Cl. CPC G06Q 30/06291; G06Q 30/0283; G06Q 30/0643

(57) ABSTRACT

A product information processing method includes: acquiring information of a plurality of second products from at least one other product information system related to a target product information system; determining a plurality of same-model/similar-model product pairs by performing a matching determination between the plurality of second products and a plurality of first products in the target product information system; respectively acquiring price information of the first product and the second product in the product pairs, wherein the price information includes: respective product price information and logistics price information for sales to users in a plurality of destination countries/regions in a corresponding product information system; and providing comparison result information from a price comparison of the first product and the second product in the product pairs on a destination country/region dimension.

### CROSS-REFERENCE TO RELATED APPLICATION

This application is a Continuation Application of International Patent Application No. PCT/CN2024/088089, filed on Apr. 16, 2024, which is based on and claims priority to and benefits of Chinese Patent Application No. 202310459734.5, filed with the China National Intellectual Property Administration on Apr. 24, 2023, and titled “PRODUCT INFORMATION PROCESSING METHOD AND ELECTRONIC DEVICE.” The entire content of the above-referenced applications is incorporated herein by reference.

### TECHNICAL FIELD

The present application relates to the field of information processing technologies, and in particular, to a product information processing method and an electronic device.

### BACKGROUND

In a product information service platform, product is the most fundamental and core information. The platform needs to provide buyers with a rich and high-quality supply of products, so that buyer users can visit the platform to access products, and subsequently perform actions such as clicking and placing orders for purchase. Metrics such as click-through rate (CTR) and browse-to-purchase conversion rate are important indicators that the platform needs to continuously monitor and improve. However, in practical applications, there may be multiple platforms that provide similar product information services. Therefore, how to provide sellers with information that helps enhance their product competitiveness in a multi-platform competitive environment, thereby improving metrics like CTR and browse-to-purchase conversion rate, is a technical problem that needs to be solved by those skilled in the art.

### SUMMARY

The present application provides a product information processing method and an electronic device, which are beneficial for improving metrics such as information click-through rate or browse-to-purchase conversion rate in a system.

The present application provides the following solutions:

A product information processing method, including:
acquiring information of a plurality of second products from at least one other product information system other than a target product information system; the target product information system and the other product information system both being product information systems that support cross-border transactions;
determining a plurality of same-model/similar-model product pairs by performing a matching determination between the plurality of second products and a plurality of first products within the target product information system, wherein each product pair includes a first product and a second product;
respectively acquiring price information of the first product and the second product in the product pairs, wherein the price information includes: respective product price information and logistics price information for sales to users in a plurality of destination countries/regions in a corresponding product information system;
providing comparison result information from a price comparison of the first product and the second product in the product pairs on a destination country/region dimension.

In some embodiments, the acquiring information of a plurality of second products includes:
acquiring, from the other product information system, information of a plurality of second products whose rankings on a product sales ranking list in the other product information system satisfy a condition, based on the product sales ranking list information, so as to, after determining same-model/similar-model first products for the plurality of second products from the target product information system, determine whether the first products have a price advantage relative to the second products.

In some embodiments, the determining a plurality of same-model/similar-model product pairs by performing a matching determination between the plurality of second products and a plurality of first products in the target product information system includes:
determining the plurality of same-model/similar-model product pairs by performing a matching determination between the plurality of second products and the plurality of first products on dimensions of image, category, key attribute, and/or sales quantity/unit; wherein the key attribute is determined based on pre-configured attribute configuration information, provided on a category dimension, that affects price.

In some embodiments, the determining the plurality of same-model/similar-model product pairs includes:
determining an image-matched first product set for the second product by performing a similarity matching between a product image of each second product and the plurality of first product images;
determining whether the plurality of first products in the first product set and the second product belong to a same category, and if not, filtering out the second product;
determining whether attribute values of the plurality of remaining first products in the first product set and the second product are consistent for key attributes, and if not consistent, filtering them out;
after respectively converting sales quantities/units of the plurality of remaining first products in the first product set and the second product into a standard sales quantity/unit, determining whether the converted values are consistent, and if not consistent, filtering them out, and determining each of the remaining first products in the first product set as a same-model/similar-model product of the second product.

In some embodiments, the performing a similarity matching between a product image of each second product and the plurality of first product images includes:
after acquiring the information of the second product from the other product information system, storing the acquired information of the second product based on a server deployed in a country/region to which the other product information system belongs, and performing the similarity matching between the product image of each second product and the plurality of first product images.

In some embodiments, the method further includes:
before storing the acquired information of the second product, performing cropping and renaming processing on the image of the second product according to a unified naming convention, wherein the unified naming convention includes identifier information of the other product information system, identifier information of the country/region to which it belongs, and identifier information obtained after performing length normalization processing on an original name of the image of the second product.

In some embodiments, the determining an image-matched first product set for the second product includes:
utilizing an image matching algorithm to perform a similarity matching between the product image of each second product and the plurality of first product images, so as to determine the image-matched first product set for the second product;
the method further includes:
after the image matching algorithm determines the image-matched first product set for the second product, generating a plurality of first evaluation tasks, wherein the first evaluation tasks are used for distribution to evaluation performers, so as to evaluate an accuracy of a matching result of the image matching algorithm, and to improve the accuracy by modifying parameters of the image matching algorithm.

In some embodiments, before determining whether the plurality of first products in the first product set and the second product belong to a same category, the method further includes:
determining a mapping relationship between each on-site category identifier in a product category system of the target product information system and each off-site category identifier in a product category system of the other product information system, so as to determine whether the plurality of first products in the first product set and the second product belong to the same category based on the mapping relationship.

In some embodiments, the determining a mapping relationship between each on-site category identifier in a product category system of the target product information system and each off-site category identifier in a product category system of the other product information system includes:
selecting a plurality of second products for each off-site category identifier from the other product information system;
predicting a matching on-site category identifier for the off-site category identifier by performing semantic analysis on title information corresponding to the plurality of second products corresponding to a same off-site category, and establishing the mapping relationship.

In some embodiments, the method further includes:
after predicting the matching on-site category identifier for the off-site category identifier, generating a plurality of second evaluation tasks based on a plurality of predicted category mapping relationships, wherein the second evaluation tasks are used for distribution to corresponding evaluation performers, so that the evaluation performers can confirm a correctness of a prediction result, and/or supplement new category mapping relationships.

In some embodiments, the respectively acquiring price information of the first product and the second product in the product pairs includes:
acquiring tiered pricing information associated with the first product and the second product in the product pairs, the tiered pricing information including: different prices corresponding to different minimum order quantities (MOQs), so as to perform a price comparison between the first product and the second product on a same MOQ dimension during the price comparison.

In some embodiments, the method further includes:
based on the comparison result information, generating a first product that has a price advantage relative to a plurality of second products on a destination country/region dimension, so as to deploy the first product set having the price advantage to a plurality of target traffic venues.

In some embodiments, the method further includes:
if it is determined based on the comparison result information that the first product does not have a price advantage relative to one or more second products when sold to users in one or more destination countries/regions, generating price optimization suggestion information for the corresponding destination country/region, so as to provide the price optimization suggestion information to a corresponding seller user for use in adjusting a price of the first product based on the optimization suggestion.

A product information processing apparatus, comprising:
a second product information acquisition unit, configured to acquire information of a plurality of second products from at least one other product information system other than a target product information system; the target product information system and the other product information system both being product information systems that support cross-border transactions;
a same-model/similar-model product identification unit, configured to determine a plurality of same-model/similar-model product pairs by performing a matching determination between the plurality of second products and a plurality of first products within the target product information system, wherein each product pair includes a first product and a second product;
a price information acquisition unit, configured to respectively acquire price information of the first product and the second product in the product pairs, wherein the price information includes: respective product price information and logistics price information for sales to users in a plurality of destination countries/regions in a corresponding product information system;
a comparison result providing unit, configured to provide comparison result information from a price comparison of the first product and the second product in the product pairs on a destination country/region dimension.

A computer-readable storage medium, on which a computer program is stored, wherein when the program is executed by a processor, the steps of the method according to any one of the preceding descriptions are implemented.

An electronic device, comprising:
one or more processors; and
a memory associated with the one or more processors, the memory being configured to store program instructions, wherein when the program instructions are read and executed by the one or more processors, the steps of any one of the methods according to the preceding descriptions are performed.

According to specific embodiments provided by the present application, the present application discloses the following technical effects:

Through an embodiment of the present application, for a certain target product transaction system that supports cross-border transactions, one or more other product information systems can be determined, and information of a plurality of second products can be acquired from the other product information systems. Subsequently, by performing a matching determination between the plurality of second products and a plurality of first products within the target product information system, a plurality of same-model/similar-model product pairs can be determined, and price information of the first product and the second product in the product pairs can be respectively acquired, wherein the price information includes: respective product price information and logistics price information for sales to users in a plurality of destination countries/regions in a corresponding product information system. In this way, comparison result information from a price comparison of the first product and the second product in the product pairs on a destination country/region dimension can be provided. Through this method, operations personnel can be helped to obtain the price comparison situation between a first product and an off-site same-model/similar-model product. This price comparison situation can then be used to guide operational strategies in the current target product information system, so as to achieve the goal of enhancing the competitive advantage of the first product relative to the same-model/similar-model second product, thereby improving metrics such as the information click-through rate or browse-to-purchase conversion rate of the first product.

Of course, any product implementing the present application does not necessarily need to achieve all the advantages described above simultaneously.

### BRIEF DESCRIPTION OF THE DRAWINGS

To more clearly explain the technical solutions in the embodiments of the present application or in the prior art, the drawings needed for use in the embodiments will be briefly introduced below. It is obvious that the drawings in the following description are merely some embodiments of the present application, and for a person of ordinary skill in the art, other drawings can be obtained based on these drawings without creative effort.

FIG. 1 is a schematic diagram of a system architecture provided by an embodiment of the present application;

FIG. 2 is a flowchart of a method provided by an embodiment of the present application;

FIG. 3 is a schematic diagram of an image comparison processing flow provided by an embodiment of the present application;

FIG. 4 is a schematic diagram of a category prediction flow provided by an embodiment of the present application;

FIG. 5 is a schematic diagram of an attribute matching flow provided by an embodiment of the present application;

FIG. 6 is a schematic diagram of an apparatus provided by an embodiment of the present application;

FIG. 7 is a schematic diagram of an electronic device provided by an embodiment of the present application.

### DETAIL DESCRIPTION OF THE EMBODIMENTS

The technical solutions in the embodiments of the present application will be clearly and completely described below with reference to the drawings in the embodiments of the present application. It is apparent that the described embodiments are only a part of the embodiments of the present application, not all of the embodiments. Based on the embodiments in the present application, all other embodiments obtained by a person of ordinary skill in the art without creative effort shall fall within the protection scope of the present application.

First, it should be noted that the inventor of the present application discovered during the implementation of the present application that an important question that needs to be answered from the perspective of product operations is whether the products sold on the platform are good and whether they are competitive compared to other platforms, in order to determine what room there is for operations and growth. Price is an important metric for measuring the market competitiveness of a product. From buyer survey reports, it can also be seen that cost-effectiveness is a core issue that buyers focus on during sourcing. This is especially true in scenarios such as cross-border e-commerce platforms that cater to B-type buyers (i.e., the buyers are also sellers). Their purpose for purchasing products from e-commerce platforms is usually for resale. Therefore, resale profit is an important metric they pursue when sourcing. This makes B-type buyers pay more attention to the product price metric when selecting products. Under the condition of equivalent performance and quality, a lower price can bring them higher resale profits. Therefore, in this scenario, if a product has sufficient competitiveness in terms of price, it will have a greater advantage in attracting traffic, improving conversion rates, and so on. Therefore, from an operations perspective, comparing the price competitiveness of same-model products across different platforms and providing corresponding operational strategies on this basis is an important means to improve platform traffic, click-through rate, conversion rate, and other metrics.

In an embodiment of the present application, to help operations personnel achieve a comparison of price competitiveness of same-model products across multiple different platforms, a corresponding processing system is provided. This system can specifically exist in the form of a tool, etc., and can specifically include functions such as data acquisition, same-model/similar-model product identification, and price analysis and comparison, so as to provide relevant comparison results to operations personnel, etc., to facilitate the provision of corresponding operational strategies by operations personnel based on the comparison results.

To facilitate understanding of the specific implementation solution provided by an embodiment of the present application, it should first be explained that for e-commerce platforms that only cater to domestic buyers and sellers, since the buyers are usually C-type buyers, i.e., ordinary consumer users, the product categories are mainly retail of clothing, daily necessities, and home appliances. The sales unit is usually “piece,” and domestic transactions are usually “free shipping” by the seller, i.e., logistics prices are basically not involved, and only the single-piece price of the product needs to be compared. Therefore, if one wants to perform same-model/similar-model product identification, price analysis and comparison, etc., between different e-commerce platforms, it is relatively easy to implement.

However, in cross-border e-commerce scenarios, the specific buyer users are usually B-type users, i.e., the buyers are also sellers, and their purpose of purchase is usually for resale. The product categories involved may be more complex (for example, they may involve large machinery and equipment such as excavators, or production line equipment, etc.), and may even involve wholesale situations (compared to single-piece retail, wholesale prices may be lower, and tiered prices may be set, for example, 0 to 100 pieces correspond to one price, 100 to 200 pieces correspond to another price, etc.); in addition, the attributes affecting the price may also be more complex. For example, when a user in a certain country/region chooses an excavator, because the local soil is mostly loose and large-tonnage excavators cannot be used, the user will usually choose a smaller-tonnage excavator. Therefore, the “tonnage” attribute becomes a key attribute that affects the sales price in different destination countries/regions. Furthermore, because cross-border transportation is involved, in terms of price, in addition to the price of the product itself, logistics prices are also involved, and the logistics prices for the same product when shipped to different countries/regions may also be different, and so on. In short, for cross-border e-commerce scenarios, it is relatively difficult to determine same-model/similar-model products among multiple different e-commerce platforms and to conduct price comparisons between these products. An embodiment of the present application provides functions related to same-model/similar-model product identification and price comparison specifically for this cross-border e-commerce scenario. Among them, optimization processing can be performed in multiple links such as data acquisition, same-model/similar-model product identification, and price analysis and comparison, to improve the accuracy and effectiveness of the comparison results. This comparison result information can be provided to operations personnel to help them determine whether a first product has a price competitive advantage relative to an off-site same-model/similar-model product, and then corresponding operational strategies can be provided for different situations to improve the platform's traffic, conversion rate, and other metrics.

Specifically, in terms of data acquisition, it mainly involves the acquisition of product information from other product information systems (since products in other product information systems are second products relative to the current target product information system, for ease of description, in the embodiments of the present application, the product information collected from other product information systems is uniformly referred to as second product information). Specifically, one can traverse layer by layer according to the category system in other product information systems to achieve full acquisition of product information in other product information systems. Alternatively, in another way, since the number of products in other product information systems may be large, if a full acquisition is performed, it may take a long time, and the workload of subsequent processes such as same-model product identification and price analysis and comparison will also be very large. Secondly, in practical applications, not all product information in other product information systems may be meaningful for improving the operational strategies of the current target product information system. Therefore, selective acquisition can also be performed. For example, one can specifically collect information of some second products with relatively high sales rankings based on some relevant product sales ranking lists in other product information systems, and then determine first products that are same-model/similar-model to these second products in the current target product information system, and then determine whether these first products have a competitive advantage in terms of price relative to the corresponding second products. This can reduce the workload and also allow for more targeted improvements to operational strategies. Certainly, during the process of collecting information from other product information systems, relevant sensitive information processing can also be performed. Information related to users, orders, etc., need not be collected; only the public product information in other product information systems is collected, including attribute information in multiple fields such as product images, titles, and prices.

In terms of same-model/similar-model product identification, in an embodiment of the present application, considering that the specific product categories in cross-border scenarios are complex, products with the same or similar images may correspond to different product categories (for example, the same image may be printed on a pillow and a bedsheet, respectively, etc.). In addition, many key attributes also have an impact on the price, and for different categories and different industries, the specific key attributes that affect the price may also be different. Furthermore, in cross-border scenarios, the sales quantity units of product information published in different countries/regions may also be different, and these will also affect the price comparison results, and so on. Therefore, when performing same-model/similar-model product identification, judgments can be made from multiple perspectives such as image matching, category matching, attribute matching, and sales quantity/unit matching to improve the accuracy of the identification results. In addition, during the identification process, some evaluation tasks can also be generated, and operations personnel, etc., can judge the identification results, and then intervene and adjust algorithm parameters, and so on.

In terms of price analysis and comparison, because the impact of logistics prices is relatively large, and the difference in logistics prices for the same product when facing users in different countries/regions will be relatively large, and even the product's own price may be different, therefore, in an embodiment of the present application, a price comparison solution on the dimension of destination country/region is provided. That is, after finding a same-model/similar-model product pair, when specifically analyzing the price of the first product and the second product in the product pair, it can be done on the dimension of the destination country/region, by respectively calculating the product price and logistics price corresponding to the first product and the second product in multiple different destination countries/regions, and then giving a comparison result of whether the specific first product has a competitive advantage in terms of price when specifically sold to users in a certain destination country/region.

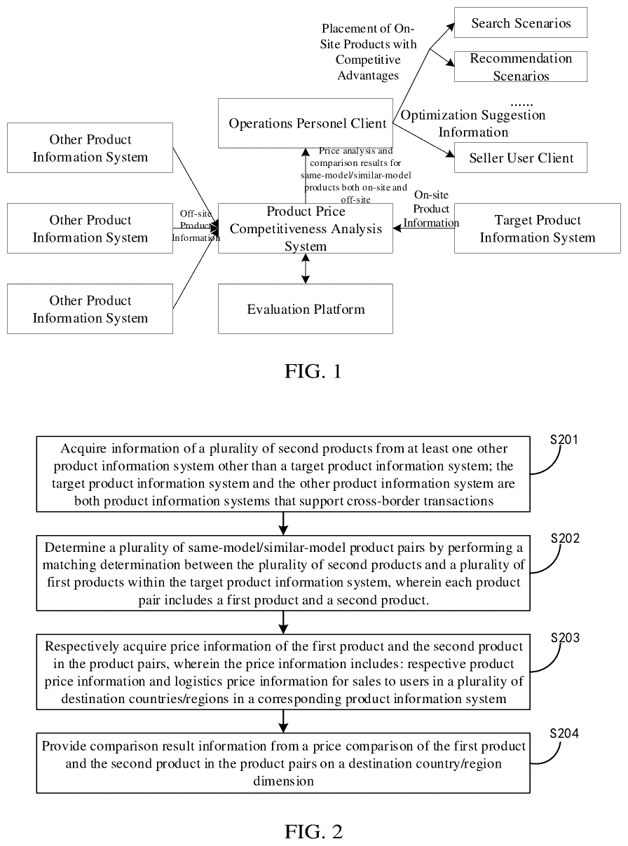

From a system architecture perspective, referring to FIG. 1, an embodiment of the present application can provide a product price competitiveness analysis system. The data acquisition, same-model/similar-model product identification, and price analysis and comparison modules of this system can all be deployed in server rooms in multiple countries/regions to achieve nearby routing of the collected data. The final processing results can be aggregated to the server in the country/region where the target product information system is located. In addition, during the analysis and processing, operations personnel may be needed for some evaluations. Therefore, it can also be connected to an evaluation platform, which is usually deployed on a server in the country/region where the target product information system is located. Therefore, if an evaluation is needed, the data can also be uniformly returned to a domestic server from the servers in various countries/regions for processing. The comparison results of the aforementioned product price competitiveness analysis system can be provided to the client of the operations personnel for their reference. The operations personnel can also select some first products with price competitive advantages based on the comparison results and deploy them to multiple specific traffic venues (for example, search scenarios, recommendation scenarios, etc.) to increase their exposure. For some first products that do not have an advantage in terms of price, if the price difference with the second product is not very large, they can be considered as potential products. Relevant optimization suggestions can be generated and provided to the corresponding seller users for optimization to enhance their competitiveness, and so on.

The specific implementation solution provided by an embodiment of the present application will be described in detail below.

First, from the perspective of the aforementioned product price competitiveness analysis system, an embodiment of the present application provides a product information processing method. Referring to FIG. 2, the method may specifically include:

S201: acquire information of a plurality of second products from at least one other product information system other than a target product information system; the target product information system and the other product information system are both product information systems that support cross-border transactions.

Here, the target product information system is the system that needs to have its operational strategies optimized, for example, it can specifically be a cross-border e-commerce platform, etc. Other product information systems, i.e., other cross-border e-commerce platforms, etc., can be determined based on the competitive situation of the specific cross-border e-commerce platform. The other product information systems can be systems belonging to the same country/region as the target product information system, or they can be product information systems from other countries/regions. Currently, the other product information systems can also be product information systems that support cross-border transactions, i.e., they can specifically sell products to buyer users in multiple countries/regions.

Specifically, when collecting product information from these other product information systems, one can traverse the category tree in the other product information systems layer by layer to obtain information on all products. Alternatively, in another approach, one can also obtain product sales ranking list information from the other product information systems. In this way, one can acquire, from the other product information system, information of a plurality of second products whose rankings on the product sales ranking list satisfy a condition (for example, information for all products on the list can be collected, or information for products ranking in the top N on the list can be collected, where this can specifically include multiple different ranking lists generated from various perspectives). That is, information can be collected for some second products with relatively good sales in other product information systems. Then, after determining same-model/similar-model first products for these well-selling second products from the target product information system, it can be determined whether the first products have a price advantage relative to these second products. If they have a price advantage, more traffic support can be provided for such price-advantaged products in the current target product information system. For example, they can be deployed more to some traffic venues (including search, homepage recommendations, etc.). Since these products that sell well in other product information systems may also have better access demand in the current target product information system, exposing these products more is beneficial for increasing the system's click-through rate. At the same time, because these products have a competitive advantage in price, it is also beneficial for further improving the click-to-purchase conversion rate. Of course, if a first product does not have a price competitive advantage relative to a second product, since the corresponding same-model second product has achieved high sales, this first product is also a relatively potential product in the current product information system. By providing corresponding optimization suggestions to the corresponding seller user, the seller user can optimize the price of the first product based on the specific suggestions to enhance its product competitiveness.

Specifically, when collecting product information, the product information, which can specifically include product images, titles, prices, etc., can be obtained from pages such as product detail pages in other product information systems through relevant data acquisition algorithms. Alternatively, in another approach, information of a plurality of second products in other product information systems can also be obtained by acquiring it from some third-party data service providers, and so on.

Of course, during the process of data acquisition from other product information service systems, a compliance review can be submitted first, and then information acquisition can be performed through specific algorithms. Subsequently, because some countries or regions may have some laws and policies regarding data collection, and some sensitive data cannot leave the specific country or region, etc., the data obtained by the specific algorithm can be stored in the algorithm's local storage space. After data verification and removal of sensitive data, it can then be transferred to the relevant servers that need to consume this data. Certainly, to improve performance, specific servers can also be deployed in multiple different countries/regions, so that the collected data can be saved to a server deployed in a nearby country/region, and so on.

It should be noted that since the product information in the product information system is constantly updated, the collection of second product information can also be performed periodically. Specifically, for some smaller-scale product information systems, a shorter update cycle can be used, for example, collection can be performed daily; while for some larger-scale product information systems, due to the large number of products, a longer update cycle can also be used, for example, product information collection can be performed every two weeks, and so on.

S202: determine a plurality of same-model/similar-model product pairs by performing a matching determination between the plurality of second products and a plurality of first products within the target product information system, wherein each product pair includes a first product and a second product.

After acquiring the information of the plurality of second products, a matching determination can be performed between the plurality of second products and the plurality of first products in the target product information system to determine a plurality of same-model/similar-model product pairs. Specifically, each product pair can be composed of one first product and one second product, to facilitate subsequent price analysis and comparison between the first product and the second product within the product pair.

As mentioned earlier, due to the complexity of product categories in cross-border scenarios, the attributes affecting the final landed price may also differ for products of different categories. In addition, the expression of product sales quantity/unit may be inconsistent in product information systems of different countries/regions, and so on. Therefore, when specifically performing same-model/similar-model product identification, the plurality of same-model product pairs can be determined by performing a matching determination between the plurality of second products and the plurality of first products on multiple dimensions such as image, category, key attribute, and/or sales quantity/unit. The specific key attribute can be determined based on pre-configured key attribute configuration information, provided on a category dimension, that affects the price for sales to users in different destination countries/regions (this will be described in detail later).

Specifically, in a specific implementation, the matching determination on the multiple dimensions of image, category, key attribute, and/or sales quantity/unit can be processed serially. That is, the specific matching process can include:

First, determining an image-matched first product set for the second product by performing a similarity matching between a product image of each second product and the plurality of first product images. For example, for a second product m, if 10 first products with image similarity satisfying a condition are determined in the target product information system through methods like image similarity calculation, then the specific first product set can include the aforementioned 10 first products.

Since products with similar images are not necessarily same-model or similar-model products, and may even belong to different categories, category matching can also be performed after completing the image matching. Specifically, it can be determined whether the plurality of first products in the first product set and the second product belong to a same category. If they do not belong to the same category, they can be filtered out. This way, only first products that are image-matched and category-matched with the second product are retained in the first product set. For example, for the second product in the aforementioned example, after determining 10 first products through image matching, it is found through category matching that two of these 10 first products have categories inconsistent with the second product, so these two first products can be filtered out.

In addition to matching on the dimensions of image and category, matching can also be performed on the dimension of key attributes. That is, it can also be determined whether the attribute values of the remaining plurality of first products in the aforementioned first product set and the second product are consistent for key attributes. If they are not consistent, they can also be filtered out, so that only first products that are image-matched, category-matched, and key-attribute-matched with the second product are retained in the first product set. That is, for the 8 remaining first products in the first product set in the aforementioned example, suppose it is found through key attribute matching that 3 of them are inconsistent with the second product in a certain key attribute (for example, suppose the second product is an excavator with a tonnage of 15 tons, while 3 first products, although their images and categories match, have a tonnage of 20 tons, which is a case of key attribute mismatch), then they can also be filtered out, and the remaining 5 first products are retained in the first product set.

After completing the key attribute matching, it can also be determined whether the specific sales quantity/unit, etc., are consistent. Specifically, the sales quantities/units of the remaining plurality of first products in the first product set and the second product can first be respectively converted into a standard sales quantity/unit, and then it is determined whether the converted values are consistent. If they are not consistent, they are filtered out. This ensures that the first product set only retains first products that are image-matched, category-matched, key-attribute-matched, and sales-quantity/unit-matched with the second product. Then, each of the remaining first products in the first product set at this time can be determined as a same-model/similar-model product of the second product. For example, suppose the sales unit of a certain second product is “pound,” while the sales unit of a certain first product is “kilogram,” even if they are converted to standard units under their respective measurement systems, the two are inconsistent. At this time, it can also be considered a case of matching failure, and so on.

In short, through the above matching calculations on multiple dimensions, for one second product, one or more first products that are same-model or similar-model can be determined. In this way, the second product can form a same-model/similar-model product pair with each of these first products. For example, for a second product M, after the above matching calculations on multiple dimensions, there are a total of three first products that match on all dimensions, namely first products x, y, and z. Then, three same-model/similar-model product pairs can be obtained, which are (first product x, second product M), (first product y, second product M), and (first product z, second product M). Certainly, the same first product (for example, the aforementioned first product x) may also appear in the same-model/similar-model first product set corresponding to other second products (for example, second product N). Therefore, this first product x can also form a same-model/similar-model product pair with second product N, and so on.

Some specific implementation details in the links of image matching, category matching, and key attribute matching are introduced below respectively.

First, regarding image matching, when specifically performing similarity matching between the product image of each second product and the plurality of first product images, since the specific image reading and matching processes are time-consuming, and practical applications also involve issues such as off-site traffic limiting and poor stability of the source site, the collected product images can first be transferred and stored in an on-site image storage service system. To improve performance, relevant servers can be deployed in multiple different countries/regions, and the aforementioned image storage service system can be deployed therein, so as to achieve nearby storage of product images. For example, suppose data of a second product is crawled from a certain website in country A, then it can be saved to a server deployed in that country A nearby, and the image storage service system therein provides a corresponding image storage solution. Subsequently, similarity matching between the product image of each second product and the plurality of first product images can also be performed on this type of server.

In addition, since image similarity matching does not have high requirements for product image resolution, before storing the collected information of the second product, the image of the second product can also be cropped to improve storage efficiency. Furthermore, since different systems have different naming conventions for product images, for the convenience of unified management, the product images can also be renamed according to a unified naming convention. The unified naming convention includes: identifier information of the other product information system, identifier information of the country/region to which it belongs, and identifier information obtained after performing length normalization processing (for example, using the MD5 algorithm, etc.) on the original name of the image of the second product.

Specifically, an image matching algorithm can be used to perform similarity matching between the product image of each second product and the plurality of first product images. The matching results output by the algorithm may be inaccurate, or because there may be large differences between different industries, a uniformly configured algorithm may have thresholds that are too high or too low for some industries. Therefore, in an optional implementation, after the image matching algorithm determines the image-matched first product set for the second product, it can also be provided to an evaluation system. In the evaluation system, a plurality of first evaluation tasks can be generated. These first evaluation tasks can be used for distribution to evaluation performers such as operations personnel. The operations personnel can then evaluate the accuracy of the matching results of the image matching algorithm, and thereby improve the accuracy by modifying the parameters of the image matching algorithm, etc.

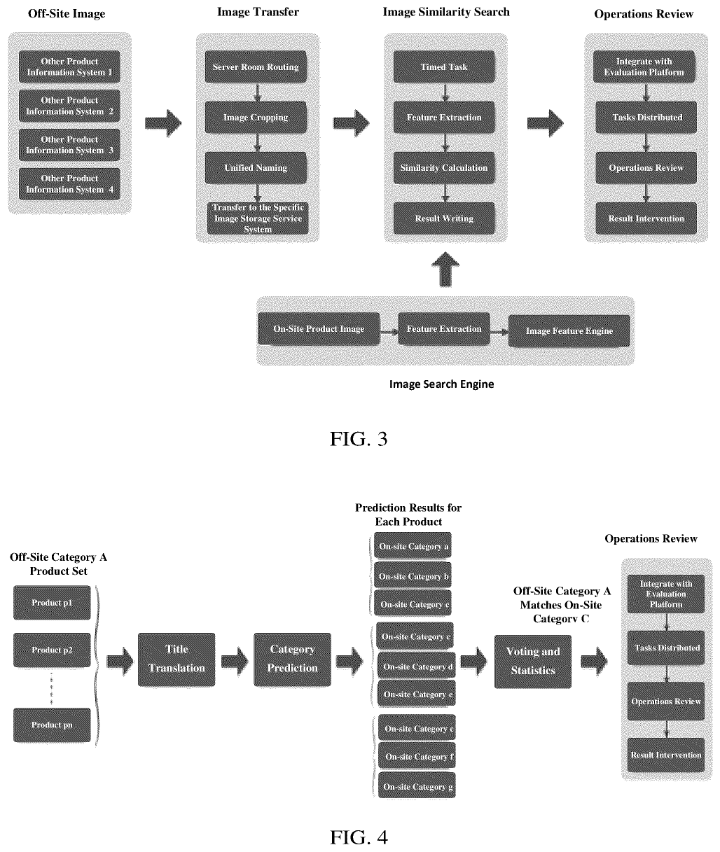

That is, in a preferred embodiment, the specific image matching can include five parts as shown in FIG. 3. First is off-site image acquisition, where product images of multiple products can be collected from other product information systems 1, 2, 3, 4, etc. After that, image transfer can be performed. During the transfer process, server room routing (for example, routing to a server room deployed in a nearby country/region, etc.), image cropping, unified naming, and transfer to the specific image storage service system can be performed. After that, the image similarity retrieval model can start a timed task to read the images of the second products from the image storage service system and perform processing such as feature extraction on the second product images. In addition, for the first product part, the on-site image retrieval engine can complete the information collection, and can also perform feature extraction and other processing. The image feature engine provides it to the image similarity retrieval model, and the image similarity retrieval model calculates the image similarity between the first product and the second product and completes the result writing. After that, the calculation results of the algorithm can be connected to the operations evaluation platform, where evaluation tasks are generated and distributed to operations personnel for evaluation. After the operations evaluation is completed, the parameters of the similarity retrieval model can also be intervened and adjusted based on the evaluation results. The specific intervention and adjustment process can be carried out separately for different categories, that is, for different categories, the specific parameter situation can also be different, so that the specific algorithm can gradually adapt to the similarity calculation needs of the specific category.

Regarding category matching, that is, determining whether a first product and a second product belong to the same product category. The problem involved here is that although products in a specific product information system usually have category labels, the product category classification systems in different product information systems may be different. Therefore, direct comparison of category labels (or comparison after translation into the same language) may be inaccurate. To address this situation, a mapping relationship between each on-site category identifier in the product category system of the target product information system and each off-site category identifier in the product category system of the other product information system can be determined in advance. Then, based on this mapping relationship, it can be determined whether the plurality of first products in the first product set and the second product belong to the same category.

There can be multiple ways to specifically determine the above mapping relationship. For example, in one way, a plurality of second products can first be selected for each off-site category identifier from the other product information system. Then, by performing semantic analysis on the title information corresponding to the plurality of second products corresponding to the same off-site category, a matching on-site category identifier can be predicted for the off-site category identifier, and the mapping relationship can be established. That is, as shown in FIG. 4, suppose the categories in the current target product information system are category a, b, c, etc.; the categories in another product information system are category A, B, C, etc.; to determine which category in the current target product information system has a mapping relationship with category A, one can first select a plurality of second products p1, p2 . . . pn, etc., belonging to category A from product information system B. Then, based on the title and other information of these second products, semantic analysis is performed to respectively determine which on-site category in the current system these second products may belong to. For example, through semantic analysis, it is found that product p1 may belong to on-site category a, or category b, or category c; product p2 may belong to on-site category c, or category d, or category e; product pn may belong to on-site category c, or category f, or category g, and so on. Then, through a voting and statistics algorithm, it can be determined that off-site category A has a mapping relationship with on-site category c in the current system, and so on. Other categories can all be processed similarly, thereby establishing a category mapping relationship between different systems through algorithmic identification.

Certainly, since the above identification of category mapping relationships is also implemented by an algorithm, there may be some identification errors or omissions. Therefore, in a specific implementation, this link can also be connected to an evaluation platform. After predicting a matching on-site category identifier for the off-site category identifier through the algorithm, a plurality of second evaluation tasks can be generated based on the plurality of predicted category mapping relationships. In this way, these second evaluation tasks can be distributed to the corresponding evaluation performers, so that the evaluation performers can confirm the correctness of the prediction results, and/or supplement new category mapping relationships. For example, specific operations personnel can judge the category mapping relationships identified by the algorithm and intervene based on the judgment results. For example, if there is a matching error, it can be modified through the evaluation platform. If an omission is found, a new category mapping relationship can also be supplemented, and so on. The intervened category mapping relationship can be saved in the system for subsequent use.

After determining the category mapping relationship between systems, category matching judgment can be performed on the second product and the image-matched first product based on this mapping relationship. For example, suppose the category to which a certain second product belongs is category 1 in product information system B; a certain first product whose image matches that of the second product belongs to category b in product information system A; and through the aforementioned category mapping relationship, it is found that category b in product information system A has a matching relationship, i.e., a mapping relationship, with category 1 in product information system B. Then, it can be determined that the category of this second product is consistent with that of this first product.

Regarding key attribute matching, as mentioned earlier, since the attributes that affect the price are different for products in different industries/categories, a solution can be adopted where operations personnel configure key attributes for specific industries/categories. That is, operations personnel can configure attributes that may specifically affect the price as key attributes based on the characteristics of products in a specific industry/category. In this way, during the process of identifying same-model/similar-model products, after completing image and category matching, when performing attribute matching, it can be determined on which attributes matching needs to be performed based on the key attribute configuration information corresponding to the specific industry/category. That is, for a specific category, matching only needs to be performed on these key attributes, while other attributes that have no impact on the price do not need to be judged for matching. For example, for excavator-type products, the specific key attributes can include tonnage, bucket capacity, etc. Then, matching judgment can be performed on the first product and the second product on these attributes, while for attributes such as color, since they are not related to the price, matching judgment does not need to be performed. In this way, for a pair of a first product and a second product, after successful image matching and category matching, as long as they are consistent in key attributes, even if they are inconsistent in attributes such as color, they can still be identified as same-model/similar-model.

Regarding the acquisition of information on various key attributes of a specific product, there can be multiple ways. For example, a specific system usually provides a standard product attribute list for a specific product. Therefore, the attribute value information of the specific product on the key attributes can first be obtained from this standard product attribute list. If some key attribute information does not exist in the standard product attribute list, attribute information fields contained therein can also be extracted from the product title, product details, and other information, and the attribute items of both are combined for the matching process on the specific key attribute dimension.

Regarding sales quantity/unit matching, since the sales quantity and unit of same-model/similar-model products on different websites may be inconsistent, and correspondingly, the corresponding product sales prices will also be different, in addition to matching in terms of image, category, key attributes, etc., matching can also be performed on the dimension of sales quantity/unit. Specifically, the sales quantity/unit of the product can first be extracted from the attribute list, and then it can also be converted into a standard sales quantity and standard unit through a unit conversion table. Then, the converted standard sales quantity/unit can be compared. If the sales quantity/unit are the same, they can be considered a same-model/similar-model product pair. Otherwise, if the sales quantity/unit are still inconsistent after conversion, they can be discarded. For example, the sales unit of a certain first product is “gongjin [kilogram],” and the sales unit of a second product is “qianke [kilogram].” After conversion, the units of both can be converted to “kilogram,” so they can be considered same-model products. However, if the sales unit of a certain first product is “kilogram,” and the sales unit of a second product is “pound,” after conversion, the standard sales unit of the first product is “kilogram,” while the standard sales unit of the second product is “pound.” At this time, since “kilogram” and “pound” are inconsistent, these two products will not be considered a same-model/similar-model product pair, and so on.

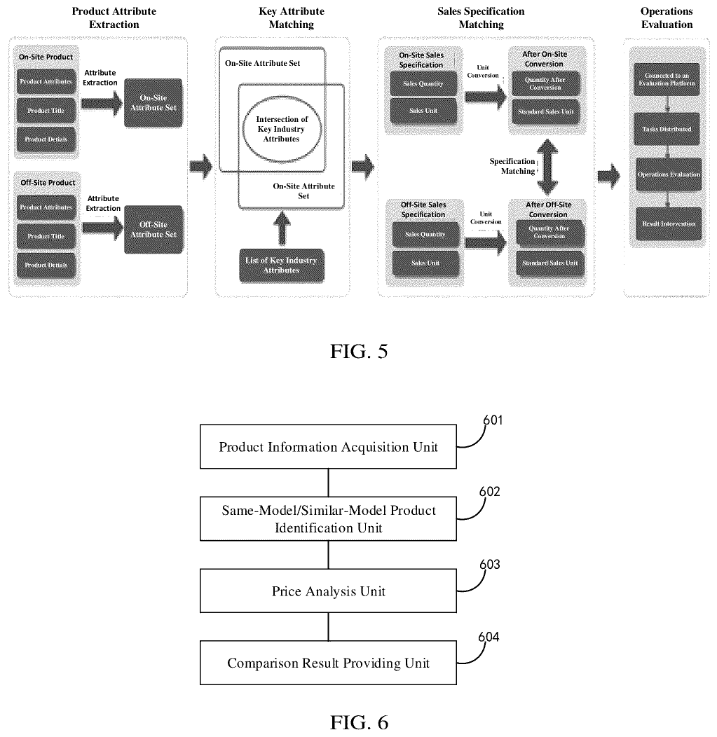

That is, regarding the aforementioned key attribute matching and sales quantity/unit matching, the specific processing flow can be as shown in FIG. 5. For on-site or second products, attribute value information on key attributes can be extracted through multiple channels such as the standard attribute list, product title, and product details. After that, important attribute (i.e., key attribute) matching can be performed. If the attribute values of the first product and the second product on the key attributes can be successfully matched, the next step of matching can be entered; otherwise, they can be filtered out. In the sales specification matching process, the main task is to convert the sales quantity and unit of the first product and the second product respectively, and then judge whether the converted quantity and unit are consistent. If they are inconsistent, they can be filtered out. Of course, in a specific implementation, after completing the matching of this step, evaluation tasks can still be generated through the evaluation platform, and operations personnel, etc., can judge the matching results, and can also intervene in the matching results, and so on.

In short, after the matching judgment of the above multiple steps, a plurality of product pairs can be determined. Each product pair can be composed of one first product and one second product, and the two are same-model or similar-model products. It should be noted that in the process of specifically performing matching judgment on information in various dimensions, it may also involve translation of product information, etc. For example, product information described in different languages in different product information systems can be translated into the same language, and then matching judgment can be performed.

S203: respectively acquire price information of the first product and the second product in the product pairs, wherein the price information includes: respective product price information and logistics price information for sales to users in a plurality of destination countries/regions in a corresponding product information system.

After obtaining such product pairs, price analysis and comparison can be performed based on these product pairs to determine whether a specific first product has a price advantage relative to a second product. Specifically, when performing price analysis and comparison, the price information of the first product and the second product can be obtained first. In an embodiment of the present application, since it mainly involves cross-border scenarios, the specific price information can be specifically divided into product price information and logistics price information. Moreover, since the product price and logistics price of the same product may be different when sold to users in different countries/regions, the product price and logistics price can be acquired and compared separately on the dimension of the specific destination country/region.

First, regarding the first product price, a product price model and a logistics price model can be specifically provided. The product price part can include a page price. The page price can specifically be a single quotation or a tiered price (i.e., different prices configured for different purchase quantities) based on the product's sales quantity and SKU configuration, etc. After that, it can also be determined whether there is a country-specific price configured based on different countries/regions (for example, the same product may have a higher price for users in country A and a lower price for users in country B, etc.). In addition, marketing prices for single-item discounts (for example, the product may participate in a marketing activity and enjoy discounts, etc.), order discounts (some discounts are at the order level, for example, some cross-store full-reduction marketing activities, etc.) can also be superimposed, and the specific product price can be finally calculated. In addition, shipping fee price information for different destination countries/regions can also be obtained. Regarding the shipping fee price information, one way is that since it is a first product, it can be obtained through the “landed price” in historical order information. The “landed price” is the price actually paid by the user for a specific order, which includes the product price and the logistics price. Therefore, the corresponding logistics price information for users in different countries/regions can be obtained from such historical orders. Alternatively, for products with a small volume of historical orders or even no historical orders, since accurate logistics price information cannot be obtained from historical order information, the product logistics price can be calculated based on the product's volume and weight, destination country/region, timeliness, and shipping line (freight forwarder, etc.).

For the second product, it can also be divided into two parts: a product price model and a logistics price model. The difference from the first product is that when specifically collecting information, off-site order information is not collected. Therefore, the specific “landed price” of the product cannot be directly obtained from the historical transaction orders of other product information systems. In this way, when determining the price information of the second product, it can be determined by separately calculating the product price and the logistics price. The product price can also be calculated through the page price (which may include country-specific prices, tiered prices, etc.), associated marketing information, etc.; regarding the logistics price, the product logistics price can also be calculated based on the product's volume and weight, destination country/region, timeliness, and shipping line (freight forwarder, etc.).

After obtaining the price information of the first product and the second product, when specifically comparing prices, the comparison can be made on the dimension of destination country/region+product. For the first product, the “landed price” of the product can be preferentially used for comparison. If the “landed price” cannot be obtained, the product price plus the logistics price of the destination country/region can be used for comparison. Of course, since the “landed price” also includes two parts, the product price and the logistics price, even if the “landed price” is used for comparison, it is actually a comparison of the sum of the product price and the logistics price.

It should be noted here that when comparing the prices of products in different product information systems, since the products published in different product information systems may use different currencies to describe the price information, currency conversion may also be involved. Specifically, the product price information in different product information systems can be converted to the same currency before comparison.

S204: provide comparison result information from a price comparison of the first product and the second product in the product pairs on a destination country/region dimension.

Through the identification of same-model/similar-model products and price analysis and comparison, a comparison result of whether the same first product has price competitiveness relative to a same-model/similar-model second product in multiple different destination countries/regions can be obtained. For example, if a certain first product M, relative to a same-model second product x, has a price of 1000 yuan when country 1 is the destination country, and the price of the second product x is 1200 yuan, then for this destination country 1, the first product M has price competitiveness relative to product y. After obtaining the above information, it can be saved. The specific saved information can include first product ID, second product ID, destination country/region ID, whether it has price competitiveness, price difference, and so on. The price difference information can be saved only for cases without price competitiveness. For example, regarding the aforementioned first product M, it is determined that the second products x, y, and z are same-model/similar-model with it. Then the comparison result for this product M can be as shown in Table 1:

TABLE 1

| First | Second | Destination | | Price |
|---|---|---|---|---|
| Product | Product | Country/Region | Has Price | Difference |
| ID | ID | ID | Competitiveness | (Yuan) |
| First | Second | Country 1 | Yes | |
| Product | Product | Country 2 | Yes | |
| M | x | Country 3 | No | 200 |
| | | Country n | Yes | |
| | Second | Country 1 | No | 300 |
| | Product | Country 2 | Yes | |
| | y | Country 3 | No | 150 |
| | | Country n | Yes | |
| | Second | Country 1 | Yes | |
| | Product | Country 2 | Yes | |
| | z | Country 3 | No | 100 |
| | | Country n | Yes | |

It should be noted here that, as mentioned earlier, both the first product and the second product may have “minimum order quantity (MOQ)” information in scenarios such as cross-border trade, and different “MOQs” may correspond to different prices, i.e., the same product SKU may have a “tiered price” situation. At this time, when specifically performing a price comparison, the price comparison between the first product and the second product can be performed on the same MOQ dimension. For example, also when comparing the price of the first product M and the second product x, if the MOQs include 1˜100, 100˜200, etc., for the same destination country 1, it can be separately indicated whether there is price competitiveness at the above different MOQs, and so on.

After obtaining the above comparison results, they can be provided to the corresponding operations personnel, who can adjust the specific operational strategies based on the specific comparison situation. It should be noted here that in practical applications, since some users may purchase a certain product from the current target product information system and then may need to resell it in other product information systems, at this time, it may also involve commissions charged by other product information systems to seller users, etc. Therefore, when determining price competitiveness, the influence of factors such as this commission price in other product information systems can also be considered. For example, this commission price can be added to the price of the second product, and then the price competitiveness of the first product relative to the second product can be calculated.

Specifically, when the operations personnel obtain the above comparison result information, there can be multiple ways to determine the corresponding operational strategy. For example, if a certain first product has a price competitiveness advantage over multiple same-model second products in multiple destination countries/regions, it can be considered a high-quality product that can be given priority for traffic support, and this high-quality product can be specifically deployed in multiple traffic venues. The specific traffic venues can include search, homepage recommendations, and so on. For example, suppose a user enters “excavator” to search in the current target product information system, then the multiple “excavator” type products that have a price competitiveness advantage over the second products in multiple destination countries/regions can be preferentially displayed to the user on the search results page. Alternatively, based on the country/region where the specific user is located, etc., the multiple “excavator” type products that have a price competitiveness advantage over the second products in that country/region can be preferentially displayed, and so on.

If a certain first product does not have a price competitiveness advantage over a same-model second product in one or more destination countries/regions, then in an embodiment of the present application, price optimization suggestion information can also be generated based on the specific price difference, etc. This price optimization suggestion information can be provided to the corresponding seller user, and the seller user can optimize and adjust the price information of the product based on this price optimization suggestion information. For example, suppose the price of a certain first product (including product price+logistics price) is 1200 yuan, and it does not have price competitiveness relative to a second product when targeting a certain destination country 1, with a price difference of 200 yuan. Then, based on this information, the generated price optimization suggestion can include: it is recommended to adjust the product price to 900˜999 yuan, and so on. In this way, after adjustment, the specific first product has price competitiveness relative to the off-site same-model product, which is beneficial for improving the browse-to-purchase conversion rate of the first product.

In summary, through an embodiment of the present application, for a certain target product transaction system that supports cross-border transactions, one or more related other product information systems can be determined, and information of a plurality of second products can be acquired. Subsequently, by performing a matching determination between the plurality of second products and the plurality of first products in the target product information system, a plurality of same-model/similar-model product pairs can be determined, and price information of the first product and the second product in the product pairs can be respectively acquired, wherein the price information includes: respective product price information and logistics price information for sales to users in a plurality of destination countries/regions in a corresponding product information system. In this way, comparison result information from a price comparison of the first product and the second product in the product pairs on a destination country/region dimension can be provided. Through this method, operations personnel can be helped to obtain the price comparison situation between a first product and an off-site same-model/similar-model product. This price comparison situation can then be used to guide operational strategies in the current target product information system, so as to achieve the goal of enhancing the competitive advantage of the first product relative to the same-model/similar-model second product, thereby improving metrics such as the information click-through rate or browse-to-purchase conversion rate in the system.

It should be noted that an embodiment of the present application may involve the use of user data. In practical applications, user-specific personal data may be used in the solutions described herein within the scope permitted by applicable laws and regulations (e.g., with explicit user consent, effective notification to the user, etc.) and in compliance with the requirements of applicable laws and regulations of the country where it is located.

Corresponding to the foregoing method embodiment, an embodiment of the present application also provides a product information processing apparatus. Referring to FIG. 6, the apparatus may include:
a product information acquisition unit 601, configured to acquire information of a plurality of second products from at least one other product information system related to a target product information system; the target product information system and the other product information system both being product information systems that support cross-border transactions;
a same-model/similar-model product identification unit 602, configured to determine a plurality of same-model/similar-model product pairs by performing a matching determination between the plurality of second products and a plurality of first products in the target product information system, wherein each product pair includes a first product and a second product;
a price analysis unit 603, configured to respectively acquire price information of the first product and the second product in the product pairs, wherein the price information includes: respective product price information and logistics price information for sales to users in a plurality of destination countries/regions in a corresponding product information system;
a comparison result providing unit 604, configured to provide comparison result information from a price comparison of the first product and the second product in the product pairs on a destination country/region dimension.

Specifically, the second product information acquisition unit may be specifically configured to:
acquire, from the other product information system, information of a plurality of second products whose rankings on a product sales ranking list in the other product information system satisfy a condition, based on the product sales ranking list information, so as to, after determining same-model/similar-model first products for the plurality of second products from the target product information system, determine whether the first products have a price advantage relative to the second products.

The same-model/similar-model product identification unit may be specifically configured to:
determine the plurality of same-model/similar-model product pairs by performing a matching determination between the plurality of second products and the plurality of first products on dimensions of image, category, key attribute, and/or sales quantity/unit; wherein the key attribute is determined based on pre-configured attribute configuration information, provided on a category dimension, that affects price.

More specifically, the same-model/similar-model product identification unit may include:
an image matching sub-unit, configured to determine an image-matched first product set for the second product by performing a similarity matching between a product image of each second product and the plurality of first product images;
a category matching sub-unit, configured to determine whether the plurality of first products in the first product set and the second product belong to a same category, and if not, filter them out, so as to determine an image-matched and category-matched second first product set for the second product;
a key attribute matching sub-unit, configured to determine whether attribute values of the plurality of first products in the second first product set and the second product are consistent for key attributes, and if not consistent, filter them out, so as to determine an image-matched, category-matched, and key-attribute-matched third first product set for the second product;
a sales quantity/unit matching sub-unit, configured to, after respectively converting sales quantities/units of the plurality of first products in the third first product set and the second product into a standard sales quantity/unit, determine whether the converted values are consistent, and if not consistent, filter them out, so as to determine an image-matched, category-matched, key-attribute-matched, and sales-quantity/unit-matched fourth first product set for the second product, and determine each of the first products in the fourth sales first product set as a same-model/similar-model product of the second product.

Specifically, the image matching sub-unit may be specifically configured to:
after acquiring the information of the second product from the other product information system, store the acquired information of the second product based on a server deployed in a country/region to which the other product information system belongs, and perform the similarity matching between the product image of each second product and the plurality of first product images.

In addition, the apparatus may further include:
an image processing unit, configured to, before storing the acquired information of the second product, perform cropping and renaming processing on the image of the second product according to a unified naming convention, wherein the unified naming convention includes identifier information of the other product information system, identifier information of the country/region to which it belongs, and identifier information obtained after performing length normalization processing on an original name of the image of the second product.

Specifically, the image matching sub-unit may be specifically configured to:
utilize an image matching algorithm to perform a similarity matching between the product image of each second product and the plurality of first product images, so as to determine the image-matched first product set for the second product;

At this time, the apparatus may further include:
a first evaluation task generation unit, configured to, after the image matching algorithm determines the image-matched first product set for the second product, generate a plurality of first evaluation tasks, wherein the first evaluation tasks are used for distribution to evaluation performers, so as to evaluate an accuracy of a matching result of the image matching algorithm, and to improve the accuracy by modifying parameters of the image matching algorithm.

In addition, the apparatus may further include:
a category mapping relationship determination unit, configured to, before determining whether the plurality of first products in the first product set and the second product belong to a same category, determine a mapping relationship between each on-site category identifier in a product category system of the target product information system and each off-site category identifier in a product category system of the other product information system, so as to determine whether the plurality of first products in the first product set and the second product belong to the same category based on the mapping relationship.

Specifically, the category mapping relationship determination unit may be specifically configured to:
select a plurality of second products for each off-site category identifier from the other product information system;
predict a matching on-site category identifier for the off-site category identifier by performing semantic analysis on title information corresponding to the plurality of second products corresponding to a same off-site category, and establish the mapping relationship.

In addition, the apparatus may further include:
a second evaluation task generation unit, configured to, after predicting the matching on-site category identifier for the off-site category identifier, generate a plurality of second evaluation tasks based on a plurality of predicted category mapping relationships, wherein the second evaluation tasks are used for distribution to corresponding evaluation performers, so that the evaluation performers can confirm a correctness of a prediction result, and/or supplement new category mapping relationships.

Specifically, the price analysis unit may be specifically configured to:
acquire tiered pricing information associated with the first product and the second product in the product pairs, the tiered pricing information including: different prices corresponding to different minimum order quantities (MOQs), so as to perform a price comparison between the first product and the second product on a same MOQ dimension during the price comparison.

In addition, the apparatus may further include:
an advantaged product information providing unit, configured to, based on the comparison result information, generate a first product that has a price advantage relative to a plurality of second products on a destination country/region dimension, so as to deploy the first product set having the price advantage to a plurality of target traffic venues.
an optimization suggestion providing unit, configured to, if it is determined based on the comparison result information that the first product does not have a price advantage relative to one or more second products when sold to users in one or more destination countries/regions, generate price optimization suggestion information for the corresponding destination country/region, so as to provide the price optimization suggestion information to a corresponding seller user for use in adjusting a price of the first product based on the optimization suggestion.

In addition, an embodiment of the present application also provides a computer-readable storage medium, on which a computer program is stored, wherein when the program is executed by a processor, the steps of any one of the previously described methods in the method embodiments are performed.

And an electronic device, including:
one or more processors; and
a memory associated with the one or more processors, the memory being configured to store program instructions, wherein when the program instructions are read and executed by the one or more processors, the steps of any one of the previously described methods in the method embodiments are performed.

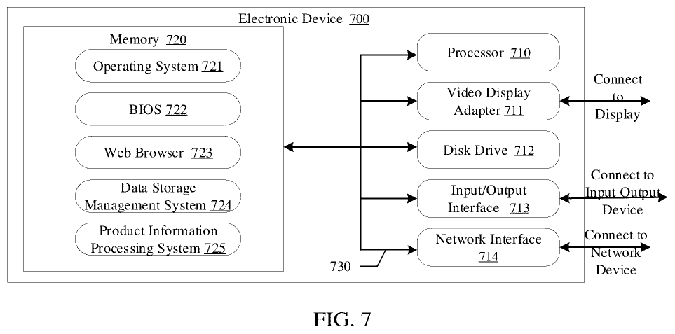

FIG. 7 exemplarily shows the architecture of an electronic device, which may specifically include a processor 710, a video display adapter 711, a disk drive 712, an input/output interface 713, a network interface 714, and a memory 720. The aforementioned processor 710, video display adapter 711, disk drive 712, input/output interface 713, network interface 714, and memory 720 can be communicatively connected via a communication bus 730.

The processor 710 can be implemented using a general-purpose CPU (Central Processing Unit), a microprocessor, an Application Specific Integrated Circuit (ASIC), or one or more integrated circuits, etc., for executing relevant programs to implement the technical solutions provided by the present application.

The memory 720 can be implemented in the form of ROM (Read Only Memory), RAM (Random Access Memory), a static storage device, a dynamic storage device, etc. The memory 720 can store an operating system 721 for controlling the operation of the electronic device 700, and a basic input/output system (BIOS) for controlling low-level operations of the electronic device 700. In addition, it can also store a web browser 723, a data storage management system 724, and a product information processing system 725, etc. The aforementioned product information processing system 725 can be the application program that specifically implements the operations of the foregoing steps in the embodiments of the present application. In short, when the technical solutions provided by the present application are implemented through software or firmware, the relevant program code is saved in the memory 720 and is called and executed by the processor 710.

The input/output interface 713 is used to connect input/output modules to realize information input and output. The input/output modules can be configured as components in the device (not shown in the figure), or can be externally connected to the device to provide corresponding functions. The input devices can include a keyboard, mouse, touch screen, microphone, various sensors, etc., and the output devices can include a display, speaker, vibrator, indicator light, etc.

The network interface 714 is used to connect a communication module (not shown in the figure) to realize communication interaction between this device and other devices. The communication module can realize communication through a wired method (e.g., USB, network cable, etc.), or through a wireless method (e.g., mobile network, WIFI, Bluetooth, etc.).

The bus 730 includes a channel for transmitting information between the various components of the device (e.g., processor 710, video display adapter 711, disk drive 712, input/output interface 713, network interface 714, and memory 720).

It should be noted that although the above device only shows the processor 710, video display adapter 711, disk drive 712, input/output interface 713, network interface 714, memory 720, bus 730, etc., in a specific implementation process, the device may also include other components necessary for normal operation. In addition, a person skilled in the art can understand that the above device may also only include the components necessary to implement the solution of the present application, and does not necessarily need to include all the components shown in the figure.

From the description of the above embodiments, a person skilled in the art can clearly understand that the present application can be implemented by means of software plus a necessary general hardware platform. Based on this understanding, the technical solution of the present application in essence, or the part that contributes to the prior art, can be embodied in the form of a software product. The computer software product can be stored in a storage medium, such as ROM/RAM, a magnetic disk, an optical disc, etc., and includes several instructions to cause a computer device (which can be a personal computer, a server, or a network device, etc.) to execute the methods described in the various embodiments of the present application or certain parts of the embodiments.

The various embodiments in this specification are described in a progressive manner. The same or similar parts between the various embodiments can be referred to each other. Each embodiment focuses on the differences from other embodiments. In particular, for the system or system embodiments, since they are basically similar to the method embodiments, the description is relatively simple, and the relevant parts can be referred to the description of the method embodiments. The system and system embodiments described above are merely illustrative. The units described as separate components may or may not be physically separate, and the components displayed as units may or may not be physical units, that is, they can be located in one place, or can be distributed to multiple network units. Some or all of the modules can be selected according to actual needs to achieve the purpose of the solution of this embodiment. A person of ordinary skill in the art can understand and implement it without creative effort.

The product information processing method and electronic device provided by the present application have been described in detail above. This article has used specific examples to explain the principles and implementation methods of the present application. The description of the above embodiments is only for helping to understand the method of the present application and its core ideas. At the same time, for a person of ordinary skill in the art, there will be changes in the specific implementation methods and application scope based on the ideas of the present application. In summary, the content of this specification should not be construed as a limitation on the present application.

What is claimed is:

1. A product information processing method, comprising:
acquiring, from at least one other product information system other than a target product information system, information of a plurality of second products, wherein the target product information system and the other product information system are both product information systems that support cross-border transactions;
determining a plurality of same-model/similar-model product pairs by performing a matching determination between the plurality of second products and a plurality of first products in the target product information system, wherein each product pair comprises a first product and a second product;
respectively acquiring price information of the first product and the second product in the product pairs, wherein the price information comprises: respective product price information and logistics price information for sales to users in a plurality of destination countries/regions in a corresponding product information system; and
providing comparison result information from a price comparison of the first product and the second product in the product pairs on a destination country/region dimension.

2. The method according to claim 1, wherein acquiring information of the plurality of second products comprises:
acquiring, from the other product information system, information of a plurality of second products whose rankings on a product sales ranking list in the other product information system satisfy a condition, based on the product sales ranking list information, so as to, after determining same-model/similar-model first products for the plurality of second products from the target product information system, determine whether the first products have a price advantage relative to the second products.

3. The method according to claim 1, wherein determining the plurality of same-model/similar-model product pairs by performing a matching determination between the plurality of second products and the plurality of first products within the target product information system comprises:
determining the plurality of same-model/similar-model product pairs by performing a matching determination between the plurality of second products and the plurality of first products on dimensions of image, category, key attribute, and/or sales quantity/unit; wherein the key attribute is determined based on pre-configured attribute configuration information, provided on a category dimension, that affects price.

4. The method according to claim 3, wherein determining the plurality of same-model/similar-model product pairs comprises:
determining an image-matched first product set for a second product by performing a similarity matching between a product image of each second product and the plurality of first product images;
determining whether the plurality of first products in the first product set and the second product belong to a same category, and if not, filtering out the first products not belonging to the same category;
determining whether attribute values of the plurality of remaining first products in the first product set and the second product are consistent for key attributes, and if not consistent, filtering them out; and
after respectively converting sales quantities/units of the plurality of remaining first products in the first product set and the second product into a standard sales quantity/unit, determining whether the converted values are consistent, and if not consistent, filtering them out, and determining each of the remaining first products in the first product set as a same-model/similar-model product of the second product.

5. The method according to claim 4, wherein the performing a similarity matching between a product image of each second product and the plurality of first product images comprises:
after acquiring the information of the plurality of second products from the other product information system, storing the acquired information of the plurality of second products based on a server deployed in a country/region to which the other product information system belongs, and performing the similarity matching between the product image of each second product and the plurality of first product images.

6. The method according to claim 5, further comprising:
before storing the acquired information of the plurality of second products, performing cropping and renaming processing on product images of the plurality of second products according to a unified naming convention, wherein the unified naming convention comprises identifier information of the other product information system, identifier information of a country/region to which it belongs, and identifier information obtained after performing length normalization processing on an original name of an image of a second product.

7. The method according to claim 4, wherein the determining an image-matched first product set for the second product comprises:
utilizing an image matching algorithm to perform a similarity matching between the product image of each second product and the plurality of first product images, so as to determine the image-matched first product set for the second product;
the method further comprising:
after the image matching algorithm determines the image-matched first product set for the second product, generating a plurality of first evaluation tasks, wherein the first evaluation tasks are used for distribution to an evaluation performer, so as to evaluate an accuracy of a matching result of the image matching algorithm, and to improve the accuracy by modifying parameters of the image matching algorithm.

8. The method according to claim 4, wherein before determining whether the plurality of first products in the first product set and the second product belong to a same category, the method further comprises:
determining a mapping relationship between each on-site category identifier in a product category system of the target product information system and each off-site category identifier in a product category system of the other product information system, so as to determine whether the plurality of first products in the first product set and the second product belong to the same category based on the mapping relationship.

9. The method according to claim 8, wherein the determining the mapping relationship between each on-site category identifier in the product category system of the target product information system and each off-site category identifier in the product category system of the other product information system comprises:
selecting a plurality of second products for each off-site category identifier from the other product information system; and
predicting a matching on-site category identifier for the off-site category identifier by performing semantic analysis on title information corresponding to the plurality of second products corresponding to a same off-site category, and establishing the mapping relationship.

10. The method according to claim 1, wherein the respectively acquiring price information of the first product and the second product in the product pairs comprises:
acquiring tiered pricing information associated with the first product and the second product in the product pairs, the tiered pricing information comprising: different prices corresponding to different minimum order quantities (MOQs), so as to perform a price comparison between the first product and the second product on a same MOQ dimension during the price comparison.

11. The method according to claim 1, further comprising:
based on the comparison result information, generating a first product that has a price advantage relative to a plurality of second products on a destination country/region dimension, and deploying a set of the first products having the price advantage to a plurality of target traffic venues.

12. The method according to claim 1, further comprising:
if it is determined based on the comparison result information that a first product does not have a price advantage relative to one or more second products when sold to users in one or more destination countries/regions, generating price optimization suggestion information for a corresponding destination country/region, and providing the price optimization suggestion information to a corresponding seller user for use in adjusting a price of the first product based on the optimization suggestion.

13. A non-transitory computer-readable storage medium configured with instructions executable by one or more processors to cause the one or more processors to perform operations comprising:
acquiring, from at least one other product information system other than a target product information system, information of a plurality of second products, wherein the target product information system and the other product information system are both product information systems that support cross-border transactions;
determining a plurality of same-model/similar-model product pairs by performing a matching determination between the plurality of second products and a plurality of first products in the target product information system, wherein each product pair comprises a first product and a second product;
respectively acquiring price information of the first product and the second product in the product pairs, wherein the price information comprises: respective product price information and logistics price information for sales to users in a plurality of destination countries/regions in a corresponding product information system; and
providing comparison result information from a price comparison of the first product and the second product in the product pairs on a destination country/region dimension.

14. The non-transitory computer-readable storage medium according to claim 13, wherein acquiring information of the plurality of second products comprises:
acquiring, from the other product information system, information of a plurality of second products whose rankings on a product sales ranking list in the other product information system satisfy a condition, based on the product sales ranking list information, so as to, after determining same-model/similar-model first products for the plurality of second products from the target product information system, determine whether the first products have a price advantage relative to the second products.

15. The non-transitory computer-readable storage medium according to claim 13, wherein determining the plurality of same-model/similar-model product pairs by performing a matching determination between the plurality of second products and the plurality of first products within the target product information system comprises:
determining the plurality of same-model/similar-model product pairs by performing a matching determination between the plurality of second products and the plurality of first products on dimensions of image, category, key attribute, and/or sales quantity/unit; wherein the key attribute is determined based on pre-configured attribute configuration information, provided on a category dimension, that affects price.

16. The non-transitory computer-readable storage medium according to claim 15, wherein determining the plurality of same-model/similar-model product pairs comprises:
determining an image-matched first product set for a second product by performing a similarity matching between a product image of each second product and the plurality of first product images;
determining whether the plurality of first products in the first product set and the second product belong to a same category, and if not, filtering out the first products not belonging to the same category;
determining whether attribute values of the plurality of remaining first products in the first product set and the second product are consistent for key attributes, and if not consistent, filtering them out; and
after respectively converting sales quantities/units of the plurality of remaining first products in the first product set and the second product into a standard sales quantity/unit, determining whether the converted values are consistent, and if not consistent, filtering them out, and determining each of the remaining first products in the first product set as a same-model/similar-model product of the second product.

17. The non-transitory computer-readable storage medium according to claim 16, wherein the performing a similarity matching between a product image of each second product and the plurality of first product images comprises:
after acquiring the information of the plurality of second products from the other product information system, storing the acquired information of the plurality of second products based on a server deployed in a country/region to which the other product information system belongs, and performing the similarity matching between the product image of each second product and the plurality of first product images.

18. The non-transitory computer-readable storage medium according to claim 17, the operations further comprising:
before storing the acquired information of the plurality of second products, performing cropping and renaming processing on product images of the plurality of second products according to a unified naming convention, wherein the unified naming convention comprises identifier information of the other product information system, identifier information of a country/region to which it belongs, and identifier information obtained after performing length normalization processing on an original name of an image of a second product.

19. The non-transitory computer-readable storage medium according to claim 16, wherein the determining an image-matched first product set for the second product comprises:
utilizing an image matching algorithm to perform a similarity matching between the product image of each second product and the plurality of first product images, so as to determine the image-matched first product set for the second product;
the method further comprising:
after the image matching algorithm determines the image-matched first product set for the second product, generating a plurality of first evaluation tasks, wherein the first evaluation tasks are used for distribution to an evaluation performer, so as to evaluate an accuracy of a matching result of the image matching algorithm, and to improve the accuracy by modifying parameters of the image matching algorithm.

20. An electronic device comprising:
one or more processors; and
one or more computer-readable memories coupled to the one or more processors and having instructions stored thereon that are executable by the one or more processors to perform one or more operations comprising:
acquiring, from at least one other product information system other than a target product information system, information of a plurality of second products, wherein the target product information system and the other product information system are both product information systems that support cross-border transactions;
determining a plurality of same-model/similar-model product pairs by performing a matching determination between the plurality of second products and a plurality of first products in the target product information system, wherein each product pair comprises a first product and a second product;
respectively acquiring price information of the first product and the second product in the product pairs, wherein the price information comprises: respective product price information and logistics price information for sales to users in a plurality of destination countries/regions in a corresponding product information system; and
providing comparison result information from a price comparison of the first product and the second product in the product pairs on a destination country/region dimension.
